(19) United States
(12) Patent Application Publication
(10) Pub. No.: US 2025/0099956 A1
(43) Pub. Date: Mar. 27, 2025

(54) CARRIER APPARATUS AND BIOMOLECULE DETECTION SYSTEM

(71) Applicant: GeneMind Biosciences Co., Ltd., Shenzhen (CN)

(72) Inventors: Weichun Han, Shenzhen (CN); Hangpeng Su, Shenzhen (CN); Yu Rao, Shenzhen (CN); Qipa Liu, Shenzhen (CN); Minghui Ma, Shenzhen (CN)

(21) Appl. No.: 18/882,857

(22) Filed: Sep. 12, 2024

(30) Foreign Application Priority Data
Sep. 21, 2023 (CN) 202322585438.8

(51) Int. Cl. B01L 3/00; B01L 9/00

(52) U.S. Cl. CPC B01L 3/502715; B01L 9/527; B01L 2200/04; B01L 2200/16; B01L 2300/0654; B01L 2300/0883; B01L 2300/18

(57) ABSTRACT

The present disclosure relates to the technical field of biomolecule detection systems and to a carrier apparatus and a biomolecule detection system. The carrier apparatus includes: a carrier structure that includes a carrier stage provided with a carrier surface configured to carry a chip, the carrier stage including a space to be vacuumized therein; and a vacuum system that communicates with the space to be vacuumized and causes a negative pressure of greater than or equal to −60 kPa to be generated in the space to be vacuumized, thereby causing the chip to be adsorbed and fixed to the carrier surface. In the carrier apparatus of the embodiments, arranging the carrier structure provided with the carrier stage including the space to be vacuumized therein in fit with the vacuum system enables the negative pressure to be generated in the space to be vacuumized to adsorption-fix the chip.

### TECHNICAL FIELD

The present disclosure relates to the technical field of biomolecule detection systems and in particular to a carrier apparatus and a biomolecule detection system.

### BACKGROUND

A gene sequencer is an instrument used for base sequence, type, and quantitative analysis of DNA fragments. It is widely used in fields such as human genome sequencing, genetic diagnosis of hereditary diseases, infectious diseases, and cancer in humans, paternity testing and individual identification in medical jurisprudence, pharmaceutical screening in bioengineering, and hybrid breeding of plants and animals. During sequencing, the gene chip needs to be fixed. Conventional gene sequencers typically use pressure devices to fix the chip being tested. For example, parts such as pressure plates or elastic clamp plates are used to abut against the surface and/or sides of the chip, and the chip being tested is then fixed to the workbench. However, as the exterior portion of the chip being tested directly bears the pressure, this contact is very likely to damage the chip, and in severe cases, it can cause the chip to break.

### SUMMARY

The present disclosure provides a carrier apparatus and a biomolecule detection system, which are used to solve the problem that chips in existing gene sequencers easily break due to the pressure that fixes them.

The present disclosure provides a carrier apparatus that includes:
a carrier structure that includes a carrier stage provided with a carrier surface configured to carry a chip, the carrier stage including a space to be vacuumized therein; and
a vacuum system that communicates with the space to be vacuumized and causes a negative pressure of greater than or equal to −60 kPa to be generated in the space to be vacuumized, thereby causing the chip to be adsorbed and fixed to the carrier surface.

The present disclosure further provides a biomolecule detection system that includes:
the carrier apparatus described above, which is configured to carry the chip, the chip being provided with a biomolecule to be detected therein;
a liquid path apparatus, configured to provide a reaction liquid for the chip so as to cause the biomolecule to undergo a biochemical reaction with the reaction liquid; and
an imaging apparatus, configured to image the reacted biomolecule.

The embodiments of the present disclosure have the following beneficial effects:

In the carrier apparatus of the embodiments, arranging the carrier structure provided with the carrier stage including the space to be vacuumized therein in fit with the vacuum system enables the negative pressure to be generated in the space to be vacuumized to fix the chip through adsorption; additionally, the generated negative pressure being greater than or equal to −60 kPa ensures that the chip can be effectively adsorbed and fixed to the carrier stage, thereby ensuring the accuracy of subsequent sequencing.

### BRIEF DESCRIPTION OF THE DRAWINGS

To more clearly illustrate the technical solutions in the embodiments of the present disclosure or the prior art, the drawings required for use in the description of the embodiments or the prior art will be briefly described below. It is obvious that the drawings in the description below are only some embodiments of the present disclosure, and other drawings can be derived from these drawings by those of ordinary skill in the art without creative efforts.

Among the drawings:

FIG. 1 is a schematic diagram of the structure of part of a biomolecule detection system according to an embodiment of the present disclosure;

FIG. 2 is a schematic diagram of a combination of a vacuum system and a carrier structure according to an embodiment of the present disclosure;

FIG. 3 is a schematic diagram of a combination of a vacuum system and a carrier structure according to another embodiment of the present disclosure;

FIG. 4 is an exploded view of a biomolecule detection system according to an embodiment of the present disclosure;

FIG. 5 is an enlarged view of area A in FIG. 4;

FIG. 6 is an exploded view of a chip carrier structure according to an embodiment of the present disclosure;

FIG. 7 is an exploded view of a thermostat assembly according to an embodiment of the present disclosure;

FIG. 8 is a schematic diagram of the structure of a heat dissipation water tank according to some embodiments of the present disclosure;

FIG. 9 is a schematic diagram of the structure of a heat dissipation structure according to another embodiment of the present disclosure; and

FIG. 10 is an exploded view of a heat dissipation structure according to another embodiment of the present disclosure.

### DETAILED DESCRIPTION

To make the objectives, technical solutions, and advantages of the present disclosure clearer, the technical solutions of the present disclosure are described below clearly and comprehensively in conjunction with the drawings in the present disclosure. It is evident that the described embodiments are part of the embodiments of the present disclosure, but not all of them. Based on the embodiments of the present disclosure, all other embodiments obtained by those of ordinary skill in the art without creative efforts fall within the scope of protection of the present disclosure.

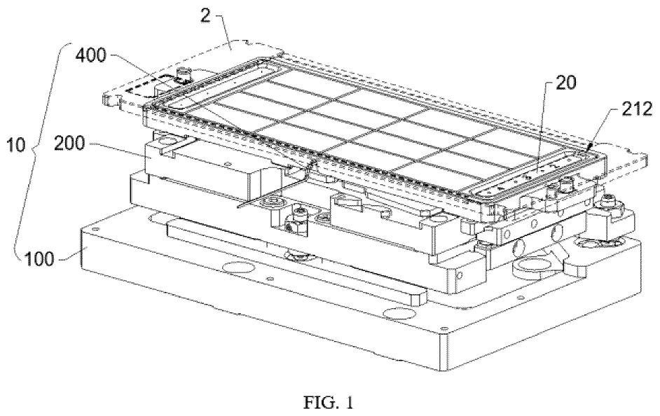

Referring to FIGS. 1 to 10, an embodiment of the present disclosure provides a carrier apparatus 10 that includes a base structure 100, a carrier structure 200, and a vacuum system 300; the base structure 100 serves as a carrier configured to mount the carrier structure 200 and may be configured for connection with an external component; the carrier structure 200 is connected to the base structure 100 and includes a carrier stage 210 provided with a carrier surface 211 configured to carry a chip 2, and the carrier surface 211 is concavely provided with an adsorption groove channel 2111 uniformly distributed on the carrier surface 211; the vacuum system 300 includes a vacuum assembly 310 that is configured to create a vacuum in a space to be vacuumized and includes a first pump 311 and a first valve 315, the first valve 315 being configured to switch between a first operating state and a second operating state; when the first valve 315 is in the first operating state, the first valve 315 communicates with the first pump 311 and the space to be vacuumized; when the first valve 315 is in the second operating state, the communication between the first pump 311 and the space to be vacuumized is cut off, and the first valve 315 communicates with the space to be vacuumized and an external atmosphere; in this embodiment, a space to be vacuumized is arranged on the adsorption groove channel 2111, and specifically, the space in the adsorption groove channel 2111 is the space to be vacuumized.

In the carrier apparatus 10 of this embodiment, arranging the carrier structure 200 provided with the adsorption groove channel 2111 in fit with the vacuum system 300 enables a negative pressure to be generated at the adsorption groove channel 2111 (which can also be understood as a space to be vacuumized) to adsorption-fix the chip 2, and the chip 2 can be separated when the negative pressure is removed; the structure is simple, and the assembly and disassembly are convenient.

The vacuum system 300 causes a negative pressure of greater than or equal to −60 kPa to be generated at the adsorption groove channel 2111 through vacuuming, ensuring that the chip 2 can be effectively adsorbed and fixed to the carrier stage 210. Several factors affect the vacuum adsorption of the chip 2 by the vacuum system 300. For example, the flatness and roughness of the carrier stage 210, the flatness of the chip 2's substrate, the vacuum degree and airflow volume of the vacuum system 300, and the like all affect the adsorption effect of the vacuum system 300 on the chip 2. This adsorption effect can be evaluated in terms of the negative pressure generated by the vacuum system 300 at the adsorption groove channel 2111. Through experiments, tests, and/or experience, it is known that when the negative pressure generated at the location described above is greater than or equal to −60 kPa, the chip 2 can be effectively adsorbed and fixed, so that subsequent sequencing, such as during liquid conveyance, will not cause slight shifts due to impact forces. This ensures the photographing and imaging effects of the optical system and thus the accuracy of the final sequencing.

The vacuum system 300 causes the negative pressure generated at the adsorption groove channel 2111 to be greater than or equal to −60 kPa and less than or equal to −100 kPa. Further, the vacuum system 300 causes the negative pressure generated at the adsorption groove channel 2111 to be greater than or equal to −80 kPa and less than or equal to −100 kPa. In addition, as the flatness of the carrier stage 210 affects the sealing between the carrier stage 210 and the vacuum system 300, the flatness of the carrier stage 210 is set to be less than or equal to 15 μm in an x direction and less than or equal to 8 μm in a y direction, which can further improve the adsorption effect of the vacuum system 300 on the chip 2. In some embodiments, the x direction is a long side direction of the carrier stage 210, and the y direction is a short side direction of the carrier stage 210; in some other embodiments, the x direction is a short side direction of the carrier stage 210, and the y direction is a long side direction of the carrier stage 210.

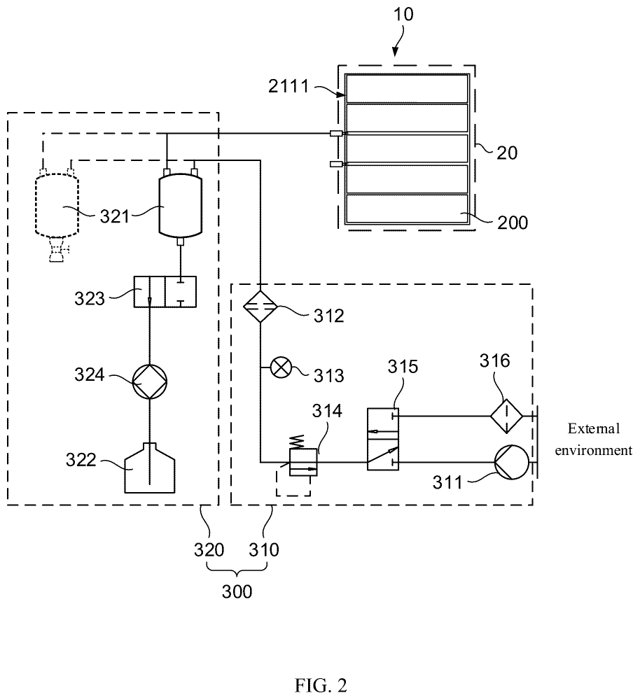

Specifically, referring to FIG. 2, the first valve 315 communicates with the space to be vacuumed through a first conduit on which a first filter 312 is arranged.

When the carrier apparatus 10 of this embodiment is used, the chip 2 is placed on the carrier structure 200 first and allowed to cover the adsorption groove channel 2111, and the first pump 311 is started to pump air so as to generate a negative pressure at the adsorption groove channel 2111; in the air pumping process of the first pump 311, the first filter 312 can filter the air in an air path between the first pump 311 and the adsorption groove channel 2111, for example, to remove dust particles, so as to prevent external substances from entering the first pump 311, thereby ensuring the operational reliability of the first pump 311.

Achievably, the first filter 312 is a vacuum filter.

Further, the first valve 315 communicates with the external atmosphere through a second conduit on which a second filter 316 is arranged.

In this embodiment, arranging the first valve 315 in fit with the first pump 311 and the second filter 316 and switching the first valve 315 enable communication with the pump 311 or the second filter 316 to be established or cut off; when communication with the pump 311 is established, a negative pressure can be generated at the adsorption groove channel 2111 through the first pump 311; when communication with the second filter 316 is established, air can be introduced through the second filter 316 to balance the internal air pressure of the second conduit. The second filter 316 is configured to filter the air introduced from the external environment into the vacuum system 300, for example, to remove dust particles.

Achievably, the second filter 316 is an air filter.

Specifically, the first valve 315 is a two-position three-way solenoid valve, and two output ports of the first valve 315 communicate with the first pump 311 and the second filter 316, respectively, the first valve 315 being capable of switching such that an input port communicates with any one of the two output ports.

It can be understood that connecting the two-position three-way solenoid valve to the first pump 311 and the second filter 316 enables the first valve 315 to switch rapidly according to electric signals, and when the carrier apparatus 10 has an automatic control function, an automatic switching control function of the carrier apparatus 10 can be fulfilled.

Further, the vacuum assembly 310 further includes a pressure detection member 313 that is connected to an air pipeline and configured to detect the air pressure of the vacuum system 300.

With this arrangement, the pressure detection element 313 can acquire air pressure signals of an air pipeline in the vacuum assembly 310 in real time, so that an operator can manually, or the carrier apparatus 10 can automatically, regulate the air pressure in the air pipeline; specifically, the pressure detection member 313 includes, but is not limited to, a physical barometer and an electronic barometer.

Further, the vacuum system 300 further includes a gas-water separation assembly 320 that communicates with the vacuum assembly 310 and the space to be vacuumized; the vacuum assembly 310 is configured to generate a vacuum negative pressure, and the gas-water separation assembly 320 is configured to separate gas and liquid in the vacuum system 300.

Due to the communication between the carrier structure 200 and the vacuum system 300, if a machine malfunction or human error occurs during sequencing or washing, liquid may leak from the carrier structure 200 into the vacuum system 300. The liquid can affect the normal operation of the vacuum system 300, particularly if the liquid contains crystals or impurities. In severe cases, this can even affect the service life of the vacuum system 300. Arranging the gas-water separation assembly 320 in fit with the vacuum assembly 310 enables the gas and liquid in the vacuum system 300 to be separated to prevent the liquid from affecting the operation of the vacuum assembly 310, thereby increasing the operational reliability of the carrier apparatus 10. In some embodiments, the vacuum assembly 310 further includes a second valve 314; the second valve 314 is a vacuum pressure regulation valve 314, and the vacuum pressure regulation valve 314 is connected to an air pipeline and configured to regulate the air pressure in the air pipeline.

In this embodiment, arranging the vacuum pressure regulation valve 314 in an air pipeline of the vacuum assembly 310 enables the vacuum pressure regulation valve 314 to regulate the air pressure inside the air pipeline such that the vacuum assembly 310 operates in a preset air pressure state.

Specifically, referring to FIG. 2, the gas-water separation assembly 320 includes a gas-water separator 321 and a liquid waste tank 322; an input port of the gas-water separator 321 communicates with the adsorption groove channel 2111, a liquid outlet of the gas-water separator 321 communicates with the liquid waste tank 322, and an air outlet of the gas-water separator 321 communicates with the vacuum assembly 310.

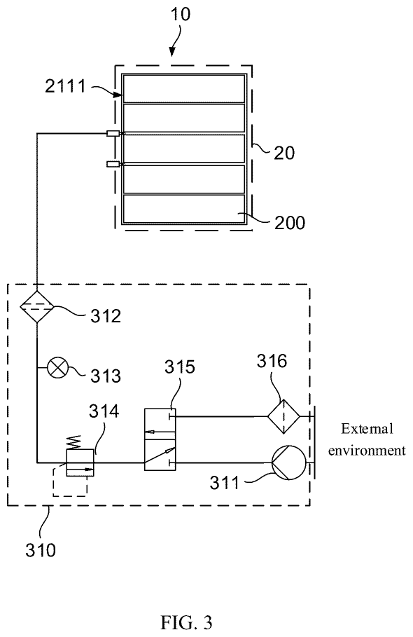

When the carrier apparatus 10 of this embodiment is used, a mixed gas output from the adsorption groove channel 2111 firstly enters the gas-water separator 321, and the gas and liquid are separated through the gas-water separator 321; the vacuum assembly 310 can output the gas through a pump to prevent the liquid from contacting the vacuum assembly 310 and thus causing the vacuum assembly 310 to malfunction; the liquid can be output to the liquid waste tank 322 through the gas-water separator 321 and stored; certainly, in some embodiments, referring to FIG. 3 (the gas-water separator is not shown in FIG. 3), the liquid waste tank 322 may not be arranged, and the liquid output by the gas-water separator 321 is directly discharged to the sewer through a conduit.

In one embodiment, the gas-water separation assembly 320 further includes a third valve 323 that communicates with the gas-water separator 321 and the liquid waste tank 322, where the third valve 323 is a two-position two-way solenoid valve or a manual valve. It can be understood that using the third valve 323 to control the communication between the gas-water separator 321 and the liquid waste tank 322 enables the communication between the two to be regulated according to the situation; when a two-position two-way solenoid valve is used, the third valve 323 can rapidly switch between establishing and cutting off communication between the gas-water separator 321 and the liquid waste tank 322 according to electric signals and can fulfill an automatic control function; when a manual valve is used, the third valve 323 can be manually opened or closed.

Further, the gas-water separation assembly 320 further includes a second pump 324 that communicates with the gas-water separator 321 and the liquid waste tank 322 and is configured to drive the liquid in the gas-water separator 321 to be conveyed toward the liquid waste tank 322.

With this arrangement, the second pump 324 can be started to pump the liquid in the gas-water separator 321 toward the liquid waste tank 322, thereby increasing the liquid discharge efficiency of the gas-water separation assembly 320.

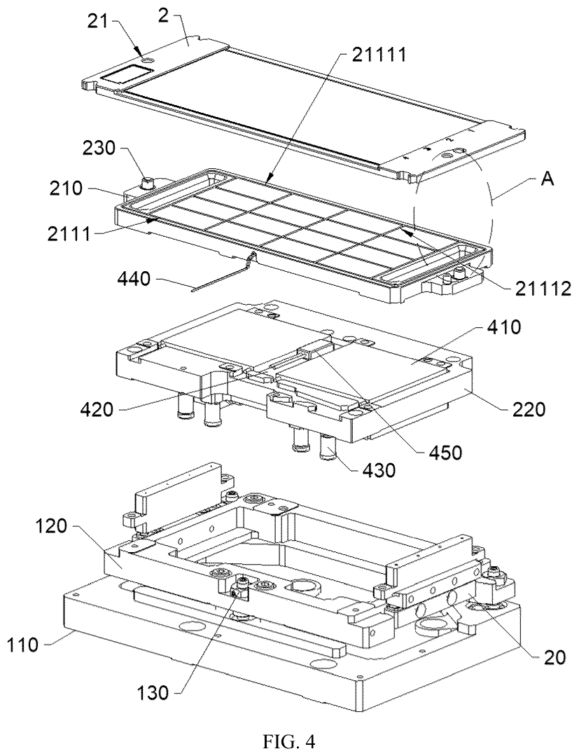

Specifically, referring to FIG. 4, the carrier structure 200 includes a heat insulation plate 220 connected to the carrier stage 210 and the base structure 100, and a thermostat assembly 400 is arranged on the inner side of the heat insulation plate 220; the thermostat assembly 400 includes a thermoelectric cooler 410 and a heat dissipation structure 420, where the thermoelectric cooler 410 is connected between the heat dissipation structure 420 and the carrier stage 210, and the heat dissipation structure 420 is configured to conduct heat of the thermoelectric cooler 410.

In this embodiment, the carrier structure 200 is further provided with a vacuum interface 213 that communicates with the adsorption groove channel 2111 and is configured for connection with the vacuum system 300; a negative pressure is generated in the adsorption groove channel 2111 through the vacuum system 300, and when the chip 2 is placed on the carrier surface 211, the chip 2 can be adsorbed and fixed to the carrier surface 211 through the negative pressure generated at an opening of the adsorption groove channel 2111; compared to a conventional solution that uses pressure to fix the chip 2, this solution can reduce the damage caused to the surface of the chip 2 due to positioning elements and meanwhile increase the fixing reliability of the carrier structure 200.

Additionally, arranging the heat insulation plate 220 in fit with the thermostat assembly 400 and the carrier stage 210 enables the heat insulation plate 220 to not only protect the thermostat assembly 400 from being damaged due to external bumps but also prevent the intense heat inside the thermostat assembly 400 from harming the operator, and also improves the use safety and durability of the carrier apparatus 10. Preferably, a through groove may be formed inside the heat insulation plate 220, the carrier stage 210 covers a side of the through groove, and the thermostat assembly 400 is accommodated in the through groove and protected by the heat insulation plate 220.

Specifically, referring to FIG. 4, the adsorption groove channel 2111 includes at least one first groove channel 21111 and at least one second groove channel 21112, and the first groove channel 21111 communicates with the second groove channel 21112.

Arranging at least one first groove channel 21111 and at least one second groove channel 21112 in communication enables a plurality of openings for adsorption of the chip 2 to be formed in the carrier surface 211; when a plurality of first groove channels 21111 and a plurality of second groove channels 21112 are provided, the adsorption range of the adsorption groove channel 2111 can be further increased, and the stability of the carrier apparatus 10 in the adsorption of the chip 2 is thus increased.

In one embodiment, the first groove channel 21111 and the second groove channel 21112 are crosswise arranged.

The crosswise arrangement of the first groove channel 21111 and the second groove channel 21112 can increase the coverage of the two on the carrier surface 211, is suitable for chips 2 with different sizes, and improves the adsorption effect of the carrier apparatus 10.

Specifically, a plurality of first groove channels 21111 are provided, spaced apart, and arranged in parallel, and a plurality of second groove channels 21112 are provided, spaced apart, and arranged in parallel, the first groove channels 21111 being perpendicular to the second groove channels 21112.

In this embodiment, the plurality of first groove channels 21111 and the plurality of second groove channels 21112 are crosswise arranged, perpendicular to each other, so that the adsorption groove channel 2111 can form openings in the carrier surface 211 that exhibit a net-like layout; when the chip 2 is placed on the carrier surface 211, the chip 2 can be adsorbed and fixed through a negative pressure generated at the openings of the adsorption groove channel 2111.

In one embodiment, the carrier surface 211 is configured to carry the chip 2, and the chip 2 is detachably connected to the carrier stage 210. It can be understood that in the embodiments described above, the chip 2 is fixed to the carrier surface 211 through vacuum adsorption, and in other embodiments, the carried chip 2 may also be fixed to the carrier surface 211 by using a detachable connection, such as magnetic attachment, adhesion, or snap-fitting.

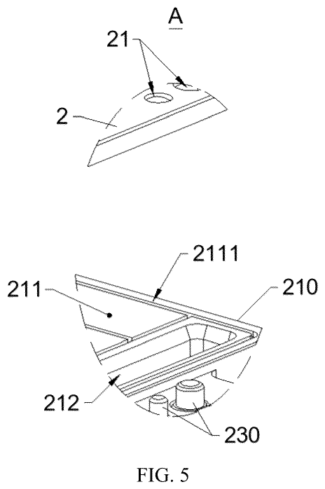

Further, referring to FIGS. 4 and 5, the carrier structure 200 further includes positioning pins 230 that are detachably connected to the carrier stage 210 and protrude from the carrier surface 211; positioning holes 21 are formed in the chip 2, and the positioning pins 230 are in plug-fit with the positioning holes 21.

With this arrangement, when the chip 2 is placed on the carrier stage 210, the chip 2 can be mounted and positioned through the fit of the positioning holes 21 and the positioning pins 230; specifically, the chip 2 includes a chip body and an external frame, where the positioning holes 21 are formed in the external frame, and the chip body is provided with a flow channel therein and configured to carry a sample to be detected; the fit of the external frame and the positioning pins 230 can prevent an external component from contacting the chip body and thus damaging its surface; in a preferred embodiment, a plurality of positioning pins 230 and a plurality of positioning holes 21 are arranged and are connected in one-to-one correspondence, where the number of positioning pins 230 located at two opposite sides of the carrier stage 210 is different; for example, one positioning pin 230 is arranged on one side of the carrier stage 210, and two positioning pins 230 are arranged on the other side of the carrier stage 210, so that a fool-proof matching function between the carrier stage 210 and the chip 2 can be fulfilled. Specifically, referring to FIGS. 1 and 4, the carrier apparatus 10 further includes a thermostat assembly 400 connected to the carrier structure 200, and the thermostat assembly 400 at least partially contacts the carrier structure 200 and exchanges heat with the carrier structure 200.

In the carrier apparatus 10 of this embodiment, arranging the carrier structure 200 provided with the adsorption groove channel 2111 in fit with the chip 2 and connecting the adsorption groove channel 2111 to the vacuum system 300 enable a negative pressure to be generated at the openings of the adsorption groove channel 2111 in the carrier surface 211, and the negative pressure can well fix the chip 2 to the carrier structure 200, so that the problem that the chip 2 is damaged due to the press-snapping manner in which the chip is fixed in existing gene sequencers can be effectively solved; then the reaction temperature of the chip 2 can be controlled through the fit of the thermostat assembly 400 and the carrier structure 200, and the use effect is good.

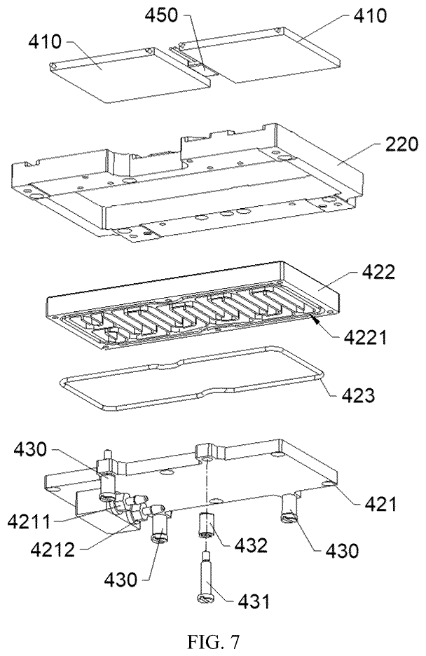

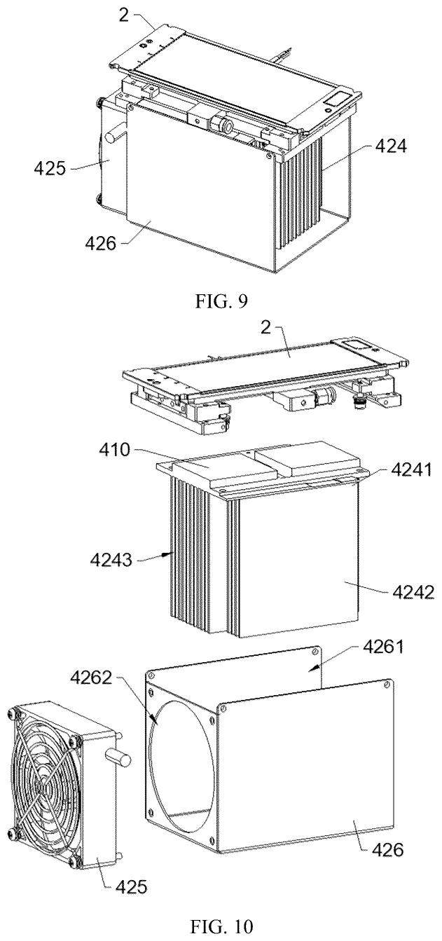

Specifically, referring to FIGS. 7 and 9, the heat dissipation structure 420 includes a heat dissipation cover plate 421 and a heat dissipation water tank 422; the heat dissipation water tank 422 is provided with a heat dissipation flow channel therein, and the heat dissipation cover plate 421 is detachably connected to the heat dissipation water tank 422 and covers the heat dissipation flow channel; the heat dissipation flow channel is configured to convey a cooling fluid and conduct heat, and a liquid inlet hole 4211 and a liquid outlet hole 4212 that communicate with the heat dissipation flow channel are formed in the heat dissipation cover plate 421.

When the heat dissipation structure 420 of this embodiment is assembled, the heat dissipation cover plate 421 and the heat dissipation water tank 422 may be hermetically connected using methods such as bonding, screw connection, or welding, and as the two are combined using a detachable connection, the processing of the heat dissipation flow channel on the heat dissipation water tank 422 is facilitated; when maintenance is needed in the future, the mere replacement of the heat dissipation cover plate 421 or the heat dissipation water tank 422 could satisfy the maintenance requirement, and the cost of use is therefore reduced.

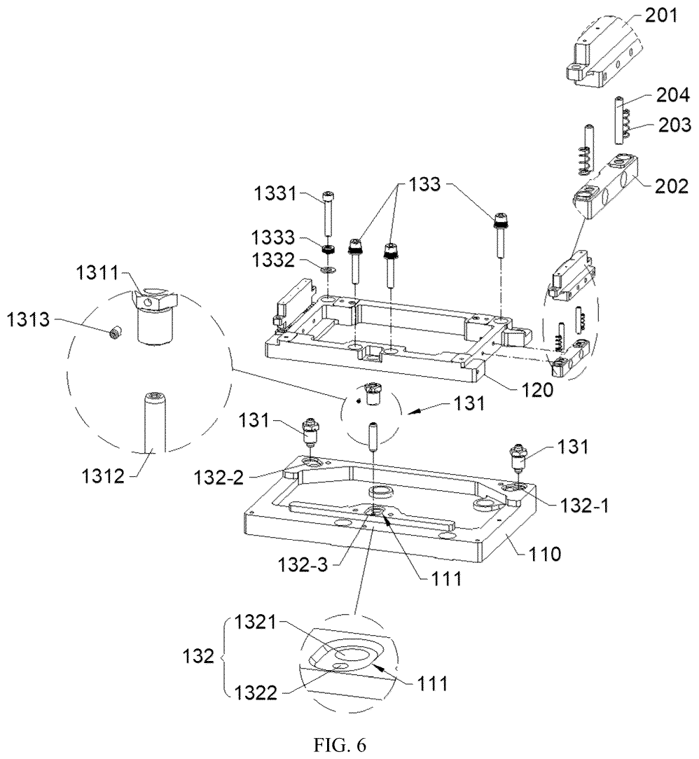

Specifically, referring to FIGS. 6 to 8, a liquid inlet hole 4211 and a liquid outlet hole 4212 that communicate with the heat dissipation flow channel are formed in the heat dissipation structure 420; specifically, the heat dissipation flow channel includes a first flow channel 4221, an intermediate flow channel 4222, and a second flow channel 4223; the first flow channel 4221 communicates with the liquid inlet hole 4211; the intermediate flow channel 4222 communicates with the first flow channel 4221 and is located on a side of the first flow channel 4221; the second flow channel 4223 communicates with the intermediate flow channel 4222 and the liquid outlet hole 4212, and the second flow channel 4223 is located on a side of the intermediate flow channel 4222 facing the first flow channel 4221; the liquid inlet hole 4211 and the liquid outlet hole 4212 are arranged on the same side of the heat dissipation structure 420, the first flow channel 4221 and the second flow channel 4223 are symmetrically arranged, and an orthographic projection of the heat dissipation flow channel on the heat dissipation structure 420 is uniformly distributed in the heat dissipation structure 420. In the heat dissipation structure 420 of this embodiment, arranging the first flow channel 4221 and the second flow channel 4223 on the same side of the intermediate flow channel 4222 can increase the length of the cooling liquid's flow path within the heat dissipation flow channel as much as possible, thereby improving the heat dissipation effect of the heat dissipation structure 420; meanwhile, arranging the liquid inlet hole 4211 and the liquid outlet hole 4212 on the same side of the heat dissipation structure 420 can facilitate the overall structural layout of the heat dissipation structure 420.

In one embodiment, the intermediate flow channel 4222 includes at least one curved section 42221, and the curved section 42221 is arranged in a curve in the heat dissipation structure 420 such that the intermediate flow channel 4222 forms a comb-shaped flow channel inside the heat dissipation structure 420.

In this embodiment, the curved section 42221 has a zigzag shape and is repeatedly bent, such that internal structures of the heat dissipation structure 420 form mutually staggered blocking structures, and the fit of the blocking structures and the intermediate flow channel 4222 causes the formation of a flow channel of a comb-shaped structure inside the heat dissipation structure 420; with this arrangement, the coverage rate of the heat dissipation flow channel on an orthographic projection of the heat dissipation structure 420 can be increased, thereby improving the heat dissipation efficiency of the heat dissipation structure 420.

In another embodiment, the intermediate flow channel 4222 further includes a connecting section 42222; one end of the connecting section 42222 communicates with the curved section 42221, and the other end of the connecting section 42222 communicates with the first flow channel 4221 or the second flow channel 4223; the connecting section 42222 is arranged in a straight line direction and positioned close to a side of the curved section 42221.

In this embodiment, arranging the connecting section 42222 connected to the curved section 42221 can increase the flow rate of the cooling liquid in the connecting section 42222 to enable the heat inside the heat dissipation structure 420 to be more quickly and more uniformly conducted to other low-temperature portions of the heat dissipation structure 420, thereby improving the heat conduction effect of the heat dissipation structure 420.

In another embodiment, at least part of the first flow channel 4221 is arranged in a curve, and an orthographic projection of the liquid inlet hole 4211 on the heat dissipation structure 420 is at least partially located on the inner side of the first flow channel 4221; and/or at least part of the second flow channel 4223 is arranged in a curve, and the orthographic projection of the liquid inlet hole 4211 on the heat dissipation structure 420 is at least partially located on the inner side of the second flow channel 4223.

At least partially arranging the first flow channel 4221 around the liquid inlet hole 4211 enables the cooling liquid to have a longer flow path within the first flow channel 4221 after entering the first flow channel 4221 through the liquid inlet hole 4211 so as to increase the heat received by the cooling liquid when the heat dissipation structure 420 conducts heat with an external heat source (i.e. an object to be heat-dissipated); additionally, as the first flow channel 4221 is arranged around the liquid inlet hole 4211, the overlapping area between the orthographic projection of the first flow channel 4221 on the heat dissipation structure 420 and the external heat source can be increased, such that the heat conduction effect and the heat dissipation effect of the heat dissipation structure 420 are further improved; meanwhile, at least partially arranging the first flow channel 4221 around the liquid inlet hole 4211 also enables the first flow channel 4221 and the liquid inlet hole 4211 to have a more compact overall structure, which helps satisfy the compact design requirement of the heat dissipation structure 420. Likewise, arranging the second flow channel 4223 around the liquid outlet hole 4212 can increase the length of the cooling liquid's flow path within the second flow channel 4223 to increase the heat output by the cooling liquid, meanwhile can also increase the overlapping area between the second flow channel 4223 and the external heat source, and also enables the second flow channel 4223 and the liquid outlet hole 4212 to have a compact overall structure, which will not be elaborated herein.

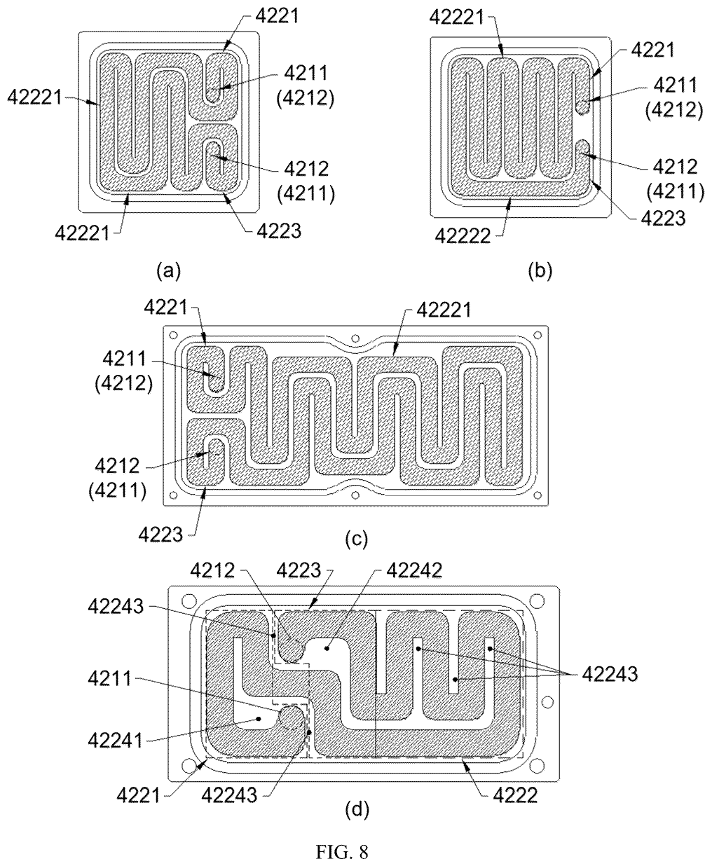

It should be noted that the term “orthographic projection” herein refers to an orthographic projection of the heat dissipation flow channel on the heat dissipation structure 420 in a direction perpendicular to a hot surface of the heat dissipation structure 420, that is, the projection mode shown in FIG. 8. In this embodiment, the heat dissipation structure 420 is provided with a flat surface configured to contact with an external component to achieve a heat dissipation effect; at least partially locating the orthographic projection of the liquid inlet hole 4211 on the heat dissipation structure 420 on the inner side of the first flow channel 4221 and at least partially locating the orthographic projection of the liquid outlet hole 4212 on the heat dissipation structure 420 on the inner side of the second flow channel 4223 enable the heat dissipation flow channel to have a longer path to surround the liquid inlet hole 4211 and the liquid outlet hole 4212 so as to increase the heat exchange between the cooling liquid and the heat dissipation structure 420, thereby improving the heat dissipation effect of the heat dissipation structure 420.

Specifically, referring to FIG. 8(a), in Embodiment One, the intermediate flow channel 4222 includes at least two curved sections 42221, and the two curved sections 42221 are in close fit with each other and connected to the first flow channel 4221 and the second flow channel 4223, respectively, such that the two curved sections 42221 are combined to form a comb-shaped curved flow channel structure; when the cooling liquid is conveyed inside the intermediate flow channel 4222, the cooling liquid can sequentially pass through the two curved sections 42221 to increase the length of the cooling liquid's flow path; this arrangement can improve the heat dissipation and heat conduction effects of the heat dissipation structure 420 and allows the heat dissipation structure 420 to have a compact overall structure, which facilitates the miniaturization of the heat dissipation structure 420.

Referring to FIG. 8(b), in Embodiment Two, the intermediate flow channel 4222 includes at least one curved section 42221 and a connecting section 42222, and the connecting section 42222 is connected between a second flow channel 4223 (a first flow channel 4221) and the curved section 42221; this arrangement enables, when the first flow channel 4221 is used as a flow channel for liquid feeding, the cooling liquid to be quickly discharged from the second flow channel 4223 through the connecting section 42222 after passing through the curved section 42221, thereby reducing heat accumulation inside the heat dissipation structure 420 to improve the heat dissipation effect of the heat dissipation structure 420.

Referring to FIG. 8(c), in Embodiment Three, the first flow channel 4221 and the second flow channel 4223 are symmetrically arranged, and the first flow channel 4221 and the second flow channel 4223 are arranged around the liquid inlet hole 4211 and the liquid outlet hole 4212, respectively, and the intermediate flow channel 4222 includes at least two curved sections 42221 in close fit with each other; this arrangement enables heat to be uniformly distributed on the surface of the heat dissipation structure 420, thereby improving the heat dissipation effect of the heat dissipation structure 420. It should be noted that the length dimension of the heat dissipation structure 420 in Embodiments One and Two may be half of the length dimension of the heat dissipation structure 420 in Embodiment Three; when the heat dissipation structure 420 in Embodiment Three needs to be replaced with the heat dissipation structure 420 in Embodiment One and/or Embodiment Two, this arrangement enables two heat dissipation structures 420 in Embodiment One or Embodiment Two to be arranged side by side to cover the surface of the external heat source as much as possible; in other embodiments, a corresponding number of heat dissipation structures 420 can be selected according to actual usage requirements to fully cover the surface of the external heat source. Specifically, in this embodiment, the thermoelectric cooler 410 is a semiconductor thermoelectric cooler 410, and the external heat source may be a hot end of the thermoelectric cooler 410.

Referring to FIG. 8(d), in Embodiment Four, the first flow channel 4221 and the second flow channel 4223 are centrosymmetric about a midpoint of a connecting line of the liquid inlet hole 4211 and the liquid outlet hole 4212, and the first flow channel 4221 and the second flow channel 4223 communicates with the intermediate flow channel 4222; a partition structure includes a first partition 42241, a second partition 42242, and flow channel partitions 42243; the first partition 42241 and the second partition 42242 are configured to separate the liquid inlet hole 4211 from the intermediate flow channel 4222, and the first flow channel 4221 can be arranged around the liquid inlet hole 4211 to increase the length of the cooling liquid's path within the heat dissipation structure 420; meanwhile, arranging a plurality of flow channel partitions 42243 in a staggered manner enables the formation of an intermediate flow channel 4222 provided with a plurality of curved sections 42221, thereby improving the heat dissipation effect of the heat dissipation structure 420.

Further, the heat dissipation structure 420 further includes a sealing ring 423 arranged between the heat dissipation cover plate 421 and the heat dissipation water tank 422, and the sealing ring 423 is arranged around the heat dissipation flow channel and configured to seal a gap between the heat dissipation cover plate 421 and the heat dissipation water tank 422.

With this arrangement, when the heat dissipation cover plate 421 and the heat dissipation water tank 422 are assembled, the sealing ring 423 seals the gap therebetween, so that the sealing effect of the heat dissipation structure 420 can be further improved; in one embodiment, a groove configured to accommodate the sealing ring 423 may be formed in one surface of the inner side of the heat dissipation cover plate 421 and/or the heat dissipation water tank 422, and the groove is arranged around the heat dissipation flow channel; during assembly, the sealing ring 423 can be positioned through the fit of the groove and the sealing ring 423, and meanwhile, after the heat dissipation cover plate 421 and the heat dissipation water tank 422 are combined, the sealing ring 423 may be pressed to be deformed and fill the groove; specifically, the sealing ring 423 includes, but is not limited to, a rubber sealing ring 423, a silica gel sealing ring 423, and a sealant. Referring to FIGS. 9 and 10, in another embodiment, the heat dissipation structure 420 includes a heat dissipation frame 424 and a fan 425; the heat dissipation frame 424 is in contact with the thermoelectric cooler 410, air guiding grooves 4243 are formed on a side of the heat dissipation frame 424 away from the thermoelectric cooler 410, and the fan 425 is arranged on a side of the air guiding grooves 4243 and configured to drive an external airflow to flow through the air guiding grooves 4243.

In this embodiment, the chip 2 is connected to the heat dissipation frame 424 through the thermoelectric cooler 410 and conducts heat, and when the thermoelectric cooler 410 is configured to cool the chip 2, the heat of the thermoelectric cooler 410 can be conducted to the heat dissipation frame 424, and the fan 425 can be started to drive external air to flow through the heat dissipation frame 424 and discharge the heat; when the chip 2 needs to be cooled, likewise, arranging the heat dissipation frame 424 in fit with the fan 425 can also fulfill a heat conduction function for the thermoelectric cooler 410 to fulfill a temperature control function of the thermostat assembly 400 for the chip 2.

Specifically, the heat dissipation frame 424 includes a heat conduction portion 4241 and a plurality of heat dissipation fins 4242; the plurality of heat dissipation fins 4242 are arranged at intervals to form the air guiding grooves 4243; a side of the heat conduction portion 4241 is in contact with the thermoelectric cooler 410, and the heat dissipation fins 4242 are arranged on a side of the heat conduction portion 4241 away from the thermoelectric cooler 410.

It can be understood that the air guiding grooves 4243 configured for air flowing are formed by arranging the heat dissipation fins 4242 at intervals, in which case arranging the plurality of heat dissipation fins 4242 can increase the overall heat dissipation area of the heat dissipation frame 424, thereby improving the heat dissipation effect of the heat dissipation frame 424.

In one embodiment, the heat dissipation structure 420 further includes a wind shield 426 including an air guiding cavity 4261 therein, and an air inlet hole 4262 that communicates with the air guiding cavity 4261 is formed in a side wall of the wind shield 426; the heat dissipation frame 424 is accommodated in the air guiding cavity 4261, and the fan 425 covers an outer side of the air inlet hole 4262.

In this embodiment, the wind shield 426 is used as a mounting carrier configured to accommodate the heat dissipation frame 424 and fix the fan 425, in which case arranging the heat dissipation frame 424 in the air guiding cavity 4261 of the wind shield 426 enables the external airflow to be guided so that the external airflow can flow in the direction of the air guiding grooves 4243, thereby improving the heat transfer efficiency of the airflow.

Referring to FIG. 6, in one embodiment, the thermostat assembly 400 further includes a thermistor 440 and/or a temperature switch 450, where the thermistor 440 is in contact with the carrier structure 200 or penetrates into the carrier structure 200 and is configured to acquire temperature signals of the carrier structure 200; the temperature switch 450 is configured to contact the carrier structure 200 and acquire temperature signals of the carrier structure 200, and meanwhile, the temperature switch 450 may be connected to a control circuit of the carrier apparatus 10; for example, when the surface temperature of the carrier structure 200 exceeds a preset temperature range, the temperature switch 450 can cause the control circuit of the carrier apparatus 10 to be powered off, so as to protect the operation of the carrier apparatus 10.

It should be noted that the carrier apparatus 10 of this embodiment further includes a control module, where the control module is in electrical and signal connection with the control circuit and in signal connection with the vacuum system 300, the thermostat assembly 400, and the carrier structure 200, such that an automatic feedback control function of the carrier apparatus 10 is fulfilled; after the chip 2 is placed on the carrier structure 200, the control module can automatically control the vacuum system 300 according to signals fed back by the vacuum system 300, and can cool or heat the carrier structure 200 through the thermoelectric cooler 410, such that the temperature of the chip 2 reaches a preset reaction temperature; specifically, the control module may be, but is not limited to, various PLCs (programmable logic controllers), STMs (STM microcontrollers, which are bit microcontrollers of ARM Cortex-M cores), single-chip microcomputers, FPGAs (field programmable gate arrays), ARMs (advanced RISC machines), and the like; the control module is arranged inside the carrier apparatus 10 and configured to directly control the carrier apparatus 10 and acquire the operational condition of the carrier apparatus 10.

Referring to FIG. 7, in one embodiment, the thermostat assembly 400 further includes connecting assemblies 430, and the connecting assembly 430 includes a connecting screw 431 and a pressing spring 432, where the connecting screw 431 penetrates into the heat dissipation structure 420 and is connected to the heat insulation plate 220, and the pressing spring 432 abuts against the connecting screw 431 and a side of the heat dissipation structure 420 away from the carrier stage 210 to drive the heat dissipation structure 420 to abut against a side of the thermoelectric cooler 410 away from the carrier stage 210.

In this embodiment, the connecting screw 431 is threadedly connected to the heat insulation plate 220, and the pressing spring 432 sleeves the connecting screw 431 and abuts against a large end of the connecting screw 431 and the heat dissipation structure 420; with this arrangement, the heat dissipation structure 420 can be driven to abut tightly against a side of the carrier stage 210 away from the chip 2 under the elastic action of the pressing spring 432, so that the heat dissipation structure 420 can fully contact the carrier stage 210 to exhibit an improved heat dissipation effect.

Further, referring to FIG. 4, the base structure 100 includes a bottom plate 110, an adjusting plate 120, and an adjusting assembly 130; the bottom plate 110 is configured for connection with an external component, and the bottom plate 110 and the adjusting plate 120 are connected through the adjusting assembly 130, and the position of the adjusting plate 120 relative to the bottom plate 110 is adjustable, the carrier structure 200 being connected to the adjusting plate 120.

With this arrangement, the bottom plate 110 is configured to be connected and fixed to the external component, and the adjusting plate 120 is configured to carry the carrier structure 200; arranging the adjusting assembly 130 which connects the bottom plate 110 and the adjusting plate 120 enables, when the carrier apparatus 10 of this embodiment is used, adjustment of the relative position between the adjusting plate 120 and the bottom plate 110 by operation of the adjusting assembly 130 according to the placement position requirement of the chip 2.

Specifically, referring to FIG. 6, the adjusting assembly 130 includes adjusting members 131, positioning insertion members 132, and fixing members 133, and at least three adjusting members 131 are provided; the positioning insertion members 132 include a line positioning member 132-1, a plane positioning member 132-2, and a point positioning member 132-3; the three adjusting members 131 are connected to the line positioning member 132-1, the plane positioning member 132-2, and the point positioning member 132-3, respectively, in one-to-one correspondence; the fixing members 133 are connected to the adjusting plate 120 and the bottom plate 110.

In this embodiment, arranging the line positioning member 132-1, the plane positioning member 132-2, and the point positioning member 132-3 in fit with the three adjusting members 131, respectively, can achieve precise positioning of the adjusting plate 120; the line positioning member 132-1 is fit with the adjusting member 131 in a line contact manner (specifically, a V-shaped groove may be formed in the line positioning member 132-1 to fit the adjusting member 131) so as to limit the rotational degree of freedom of the adjusting plate 120 relative to the bottom plate 110, the plane positioning member 132-2 is fit with the adjusting member 131 in a plane contact manner so as to limit the translational degree of freedom of the adjusting plate 120 relative to the bottom plate 110, and the point positioning member 132-3 is fit with the adjusting member 131 in a point contact manner (specifically, a groove may be formed in the point positioning member 132-3 to snap-fit the adjusting member 131) so as to limit the rotational and translational degrees of freedom of the adjusting plate 120 relative to the bottom plate 110; with this arrangement, the relative position between the adjusting plate 120 and the bottom plate 110 can be adjusted through adjustment of the three adjusting members 131, where the adjustment precision is high, the adjustment range is large, and the use effect is good. After the adjusting plate 120 is adjusted to a specified position, the relative position between the adjusting plate 120 and the bottom plate 110 is fixed by operation of the fixing members 133.

In one embodiment, mounting grooves 111 are formed on a side of the bottom plate 110 facing the adjusting plate 120, and the positioning insertion members 132 are accommodated in the mounting grooves 111.

In this embodiment, arranging the positioning insertion members 132 in the mounting grooves 111 enables a more compact structure between the adjusting plate 120 and the bottom plate 110, which helps reduce the overall thickness of the carrier apparatus 10 in a direction perpendicular to the carrier surface 211 and satisfy the compact design requirement of the carrier apparatus 10.

Specifically, referring to FIG. 6, the positioning insertion member 132 includes a connecting portion 1321 and a positioning portion 1322; the positioning insertion member 132 is fixedly connected to the bottom plate 110 through the connecting portion 1321, the positioning portion 1322 is arranged on a side of the connecting portion 1321, and the positioning insertion member 132 is in contact-fit with the adjusting member 131 through the positioning portion 1322.

With this arrangement, when the positioning insertion member 132 is assembled, the positioning insertion member 132 can be firstly mounted in the mounting groove 111 and fixedly connected to the bottom plate 110 through the connecting portion 1321, and then the adjusting member 131 is fit with the positioning portion 1322; the structure is simple, and the assembly is convenient.

In one embodiment, the adjusting member 131 includes an adjusting nut 1311 and an adjusting screw 1312; the adjusting nut 1311 is connected to the adjusting plate 120, and the adjusting screw 1312 penetrates into the adjusting nut 1311 and abuts against the positioning insertion member 132.

Arranging the adjusting nut 1311 in fit with the adjusting screw 1312 enables the position of the adjusting plate 120 on the bottom plate 110 to be adjusted through the mere adjustment of the relative position of the adjusting screw 1312 in the adjusting nut 1311, where the adjusting nut 1311 is firstly fixedly connected to the adjusting plate 120 through, for example, threaded connection, snap-fitting, or welding, and then threadedly connected to the adjusting screw 1312, and an end of the adjusting screw 1312 is allowed to abut against the positioning insertion member 132. Specifically, the adjusting screw 1312 may be an internal hex adjuster. With the internal hex adjuster, a spherical end of the adjusting screw 1312 can abut against the positioning insertion member 132 and provide an elastic buffering force for the contact between the two; the adjusting member 131 has a more compact overall structure, and the use is convenient.

Further, the adjusting member 131 further includes a locking member 1313 threadedly connected to the adjusting nut 1311, and rotating the locking member 1313 enables an end of the locking member 1313 to abut against or detach from the adjusting screw 1312 so as to limit or free the relative rotation between the adjusting screw 1312 and the adjusting nut 1311; with this arrangement, when the locking member 1313 limits the rotation of the adjusting screw 1312, the firmness of the adjusting member 131 can be improved, thereby preventing the adjusting assembly 130 from being accidentally freed, and the reliability of the base structure 100 is also improved.

Specifically, referring to FIG. 6, the fixing member 133 includes a fixing screw 1331, a Belleville spring 1333, and a fixing washer 1332; the fixing screw 1331 penetrates into the adjusting plate 120 and is connected to the bottom plate 110, the Belleville spring 1333 and the fixing washer 1332 both sleeve the fixing screw 1331, and the Belleville spring 1333 is configured to press the adjusting plate 120 tightly toward the bottom plate 110.

In this embodiment, arranging the Belleville spring 1333 and the fixing washer 1332 in fit with the fixing screw 1331 enables the fixing washer 1332 to increase the force-bearing area on the adjusting plate 120 and thus the pressing stability of the fixing screw 1331, and meanwhile enables the Belleville spring 1333 to apply elastic forces toward the fixing screw 1331 and the fixing washer 1332, respectively, to drive the fixing member 133 to press the adjusting plate 120 tightly against the bottom plate 110 under the elastic acting forces, thereby fixing the relative position of the adjusting plate 120 on the bottom plate 110; the structure is simple, and the operation is convenient. In a preferred embodiment, a hole may be formed in the adjusting plate 120, and the fixing washer 1332 and the Belleville spring 1333 are accommodated in the hole, such that the overall structure is more compact after the fixing member 133 and the adjusting plate 120 are combined, and the fixing washer 1332 and the Belleville spring 1333 can also be protected.

The present disclosure further provides a biomolecule detection system 1 that includes the carrier apparatus 10 according to any one of the embodiments described above, a liquid path apparatus, and an imaging apparatus; the carrier apparatus 10 is configured to carry the chip 2, and the chip 2 is provided with a biomolecule to be detected therein; the liquid path apparatus is configured to provide a reaction liquid for the chip 2 so as to cause the biomolecule to undergo a biochemical reaction with the reaction liquid; the imaging apparatus is configured to image the reacted biomolecule.

It can be understood that in the biomolecule detection system 1 of this embodiment, arranging the carrier apparatus 10 according to any one of the embodiments described above, in which the carrier structure 200 provided with the adsorption groove channel 2111 is arranged in fit with the chip 2 and the adsorption groove channel 2111 is connected to an external vacuum air source, enables a negative pressure to be generated at the openings of the adsorption groove channel 2111 in the carrier surface 211, and the negative pressure can well fix the chip 2 to the carrier structure 200, so that the problem that the chip 2 is damaged due to existing gene sequencers can be effectively solved; then the reaction temperature of the chip 2 can be controlled through the fit of the thermostat assembly 400 and the carrier structure 200, and the use effect is good. After the chip 2 is fixed to the carrier stage 210 through vacuum adsorption, fluid conveying holes of the chip 2 can correspond to manifold assemblies 20, and the manifold assemblies 20 drive a detection fluid to flow through a lane of the chip 2 to fulfill a detection function of the biomolecule detection system 1.

Further, referring to FIGS. 4 and 5, mounting holes 212 are formed in the carrier structure 200; the manifold assembly 20 includes a manifold 201, a manifold seat 202, and floating springs 203, where the manifold 201 penetrates through the mounting hole 212, the manifold seat 202 is connected to the base structure 100, and the floating springs 203 are connected to the manifold 201 and the manifold seat 202 and are configured to drive the manifold 201 to abut against the chip 2.

With this arrangement, when the manifold assemblies 20 are fit with the carrier stage 210, the manifolds 201 can be inserted into the mounting holes 212 of the carrier stage 210 and positioned through the mounting holes 212, so that the manifold assemblies 20 can communicate with the liquid conveying holes of the chip 2; specifically, two manifold assemblies 20 are provided, and the two manifold assemblies 20 communicate with two opposite ends of the lane of the chip 2, the two manifold assemblies 20 are configured for liquid feeding and liquid discharging.

After the chip 2 contacts the manifold 201, arranging the floating springs 203 connected to the manifold 201 and the manifold seat 202 can provide an elastic acting force for the two to buffer impact force between the chip 2 and the manifold 201, and meanwhile, the manifold 201 can be pressed tightly against the chip 2 under the elastic acting force so as to ensure the sealing performance between the chip 2 and the manifold 201.

Referring to FIG. 6, in one embodiment, the manifold assembly 20 further includes flow channel guiding pins 204 detachably connected to the manifold seat 202, and the manifold 201 is in slidable fit with the flow channel guiding pins 204.

With this arrangement, when the manifold 201 moves relative to the manifold seat 202, the flow channel guiding pins 204 can be slidably fit with the manifold 201 to guide the movement of the manifold 201, thereby improving the moving smoothness of the manifold 201; additionally, the flow channel guiding pins 204 can limit the axial movement of the manifold 201 along the flow channel guiding pins 204, improving the fit precision of the chip 2 and the manifold 201.

Further, referring to FIG. 5, the adsorption groove channel 2111 is arranged at least partially around the mounting hole 212.

With this arrangement, the space occupancy rate of the openings of the adsorption groove channel 2111 in the carrier surface 211 can be increased to increase the adsorption range of the adsorption groove channel 2111 on the surface of the chip 2 when the adsorption groove channel 2111 adsorbs the chip 2 and thereby improve the adsorption effect of the adsorption groove channel 2111; meanwhile, the structure can be more compact after the carrier stage 210 and the manifolds 201 are combined.

In another embodiment, mounting holes 212 are formed in the carrier structure 200; the manifold assembly 20 includes a manifold 201, a manifold seat 202, and a fastener, where the manifold 201 penetrates through the mounting hole 212, and the fastener is connected to the manifold 201 and the manifold seat 202 and configured to drive the manifold 201 to abut against the chip 2.

In this embodiment, using the fastener to connect the manifold 201 and the manifold seat 202, compared to the embodiment described above, enables the two to be rigidly fixed to improve the connection strength of the manifold 201 and the manifold seat 202; specifically, the fastener includes, but is not limited to, a screw, a pin, and a snap.

In the description of the embodiments of the present disclosure, it should be noted that orientational or positional relationships indicated by terms such as “central”, “longitudinal”, “transverse”, “upper”, “lower”, “front”, “rear”, “left”, “right”, “vertical”, “horizontal”, “top”, “bottom”, “inner”, “outer”, and the like are those shown on the basis of the accompanying drawings, and are merely intended to facilitate and simplify the description of the embodiments of the present disclosure rather than indicate or imply that the indicated device or element must have a specific orientation and be configured and operated according to the specific orientation. Such relationships should not be construed as limiting the embodiments of the present disclosure. In addition, the terms “first”, “second”, and “third” are used for descriptive purposes only and should not be construed as indicating or implying relative importance.

In the description of the embodiments of the present disclosure, it should be noted that unless otherwise clearly specified and defined, the terms “link” and “connect” should be interpreted in their broad sense. For example, the connection may be a fixed connection, detachable connection, or integral connection; a mechanic connection or electric connection; or a direct connection or indirect connection through an intermediate. For those of ordinary skill in the art, the specific meanings of the terms described above in the embodiments of the present disclosure can be interpreted according to specific conditions.

In the embodiments of the present disclosure, unless otherwise clearly specified and defined, a first feature being “above” or “under” a second feature may refer to that the first feature and the second feature are in direct contact, or the first feature and the second feature are in indirect contact through an intermediate. Also, a first feature being “on”, “over” and “above” a second feature may refer to that the first feature is right above or obliquely above the second feature, or simply mean that the first feature is at a higher horizontal position than the second feature. A first feature being “under”, “beneath” and “below” a second feature may refer to that the first feature is right below or obliquely below the second feature, or simply mean that the first feature is at a lower horizontal position than the second feature.

Reference throughout this specification to “an embodiment”, “one embodiment”, “another embodiment”, “some embodiments”, “an example”, “a specific example”, “another example”, or “some examples”, means that a particular feature, structure, material, or characteristic described in connection with the embodiment or example is included in at least one embodiment or example of the present disclosure. In the specification, the schematic expression of the terms described above does not necessarily refer to the same embodiment or example. Furthermore, the particular features, structures, materials, or characteristics may be combined in any suitable manner in any one or more embodiments or examples. In addition, in the absence of contradiction, those skilled in the art can combine the different embodiments or examples described in this specification or combine the features of different embodiments or examples.

Finally, it should be noted that: the above embodiments are intended to only describe, rather than limit, the technical solutions of the present disclosure; although the present disclosure has been described in detail with reference to the foregoing embodiments, it should be understood by those of ordinary skill in the art that: modifications can still be made to the technical solutions described in the foregoing embodiments, or some of the technical features can be equivalently replaced; and these modifications or replacements do not cause the nature of the corresponding technical solutions to depart from the spirit and scope of the technical solutions of the embodiments of the present disclosure.

1-43. (canceled)

44. A carrier apparatus, comprising:
a carrier structure that comprises a carrier stage provided with a carrier surface configured to carry a chip, the carrier stage comprising a space to be vacuumized therein; and
a vacuum system that communicates with the space to be vacuumized and causes a negative pressure of greater than or equal to −60 kPa to be generated in the space to be vacuumized, thereby causing the chip to be adsorbed and fixed to the carrier surface.

45. The carrier apparatus according to claim 44, wherein the vacuum system comprises a vacuum assembly;
the vacuum assembly comprises a first pump and a first valve, the first valve being configured to switch between a first operating state and a second operating state;
when the first valve is in the first operating state, the first valve communicates with the first pump and the space to be vacuumized;
when the first valve is in the second operating state, communication between the first pump and the space to be vacuumized is cut off, and the first valve communicates with the space to be vacuumized and an external atmosphere.

46. The carrier apparatus according to claim 45, wherein the first valve communicates with the space to be vacuumized through a first conduit on which a first filter is arranged;
the first valve communicates with the external atmosphere through a second conduit on which a second filter is arranged;
a pressure detection member is arranged on the first conduit, the pressure detection member being configured to detect an air pressure of the vacuum system;
a second valve is arranged on the first conduit, the second valve being configured to regulate the air pressure of the vacuum system.

47. The carrier apparatus according to claim 45, wherein the vacuum system further comprises a gas-water separation assembly that communicates with the vacuum assembly and the space to be vacuumized and is configured to separate gas and liquid in the vacuum system.

48. The carrier apparatus according to claim 47, wherein the gas-water separation assembly comprises a gas-water separator and a liquid waste tank, and the gas-water separator comprises a first port that communicates with the space to be vacuumized, a second port that communicates with the liquid waste tank, and a third port that communicates with the vacuum assembly;
the gas-water separation assembly further comprises a third valve that communicates with the gas-water separator and the liquid waste tank;
the gas-water separation assembly further comprises a second pump that communicates with the gas-water separator and the liquid waste tank and is configured to drive a liquid in the gas-water separator to be conveyed toward the liquid waste tank.

49. The carrier apparatus according to claim 44, wherein the carrier surface is concavely provided with an adsorption groove channel uniformly distributed on the carrier surface, and the space to be vacuumized is arranged on the adsorption groove channel; the adsorption groove channel comprises at least one first groove channel and at least one second groove channel, and the first groove channel communicates with the second groove channel.

50. The carrier apparatus according to claim 49, wherein the first groove channel and the second groove channel communicate with each other and are crosswise arranged;
a plurality of first groove channels are provided, spaced apart, and arranged in parallel, and a plurality of second groove channels are provided, spaced apart, and arranged in parallel, the first groove channels being perpendicular to the second groove channels.

51. The carrier apparatus according to claim 44, wherein the chip is detachably connected to the carrier stage.

52. The carrier apparatus according to claim 51, wherein the carrier structure further comprises positioning pins that are detachably connected to the carrier stage and protrude from the carrier surface; positioning holes are formed in the chip, and the positioning pins are in plug-fit with the positioning holes.

53. The carrier apparatus according to claim 44, further comprising a thermostat assembly, at least part of which is in contact with the carrier stage.

54. The carrier apparatus according to claim 53, wherein the carrier structure comprises a heat insulation plate that surrounds the thermostat assembly and is connected to the carrier stage.

55. The carrier apparatus according to claim 53, wherein the thermostat assembly comprises a thermoelectric cooler and a heat dissipation structure; the thermoelectric cooler is connected between the heat dissipation structure and the carrier stage, and the heat dissipation structure is configured to exchange heat with the thermoelectric cooler;
the thermostat assembly further comprises connecting assemblies, and the connecting assembly comprises a connecting screw and a pressing spring, the pressing spring abutting against the connecting screw and a side of the heat dissipation structure away from the carrier structure to drive the heat dissipation structure to abut against a side of the thermoelectric cooler away from the carrier structure;
the heat dissipation structure comprises a heat dissipation cover plate and a heat dissipation water tank; the heat dissipation water tank is provided with a heat dissipation flow channel therein, and the heat dissipation cover plate is detachably connected to the heat dissipation water tank and covers the heat dissipation flow channel; the heat dissipation flow channel is configured to convey a cooling fluid and conduct heat, and a liquid inlet hole and a liquid outlet hole that communicate with the heat dissipation flow channel are formed in the heat dissipation cover plate;
the heat dissipation flow channel comprises a first flow channel, an intermediate flow channel, and a second flow channel, and the first flow channel communicates with the liquid inlet hole; the intermediate flow channel communicates with the first flow channel and is located on a side of the first flow channel; the second flow channel communicates with the intermediate flow channel and the liquid outlet hole and is located on a side of the intermediate flow channel facing the first flow channel;
wherein the liquid inlet hole and the liquid outlet hole are arranged on the same side of the heat dissipation structure, the first flow channel and the second flow channel are symmetrically arranged, and an orthographic projection of the heat dissipation flow channel on the heat dissipation structure is uniformly distributed in the heat dissipation structure;
the intermediate flow channel comprises at least one curved section, and the curved section is arranged in a curve in the heat dissipation structure such that the intermediate flow channel forms a comb-shaped flow channel inside the heat dissipation structure;
the intermediate flow channel further comprises a connecting section; one end of the connecting section communicates with the curved section, and the other end of the connecting section communicates with the first flow channel or the second flow channel; the connecting section is arranged in a straight line direction and located on a side of the curved section;
the first flow channel and the second flow channel are centrosymmetric about a midpoint of a connecting line of the liquid inlet hole and the liquid outlet hole, and the first flow channel and the second flow channel communicate with the intermediate flow channel;
the intermediate flow channel comprises at least two communicating curved sections, wherein a liquid inlet of one of the curved sections communicates with the first flow channel, a liquid outlet of another curved section communicates with the second flow channel, and the two curved sections exhibit a comb-shaped layout;
the heat dissipation structure has a dimension in a first direction that is greater than a dimension thereof in a second direction, the first direction is perpendicular to the second direction, the first flow channel and the second flow channel are symmetrically arranged, and the first flow channel and the second flow channel are arranged around the liquid inlet hole and the liquid outlet hole, respectively, and the intermediate flow channel comprises at least two curved sections in close fit with each other, and an overall structure of the intermediate flow channel extends in the first direction;
at least part of the first flow channel is arranged in a curve, and an orthographic projection of the liquid inlet hole on the heat dissipation structure is at least partially located in the first flow channel; and/or at least part of the second flow channel is arranged in a curve, and the orthographic projection of the liquid inlet hole on the heat dissipation structure is at least partially located in the second flow channel;
the heat dissipation structure further comprises a sealing ring arranged between the heat dissipation cover plate and the heat dissipation water tank, and the sealing ring is arranged around the heat dissipation flow channel and configured to seal a gap between the heat dissipation cover plate and the heat dissipation water tank.

56. The carrier apparatus according to claim 55, wherein the heat dissipation structure comprises a heat dissipation frame and a fan; the heat dissipation frame is in contact with the thermoelectric cooler, air guiding grooves are formed on a side of the heat dissipation frame away from the thermoelectric cooler, and the fan is arranged on a side of the air guiding grooves and configured to drive an external airflow to flow through the air guiding grooves.

57. The carrier apparatus according to claim 56, wherein the heat dissipation frame comprises a heat conduction portion and a plurality of heat dissipation fins; the plurality of heat dissipation fins are arranged at intervals to form the air guiding grooves; a side of the heat conduction portion is in contact with the thermoelectric cooler, and the heat dissipation fins are arranged on a side of the heat conduction portion away from the thermoelectric cooler;
the heat dissipation structure further comprises a wind shield comprising an air guiding cavity therein, and an air inlet hole that communicates with the air guiding cavity is formed in a side wall of the wind shield; the heat dissipation frame is accommodated in the air guiding cavity, and the fan covers an outer side of the air inlet hole.

58. The carrier apparatus according to claim 55, wherein the thermostat assembly further comprises a thermistor arranged on a side of the carrier structure; and/or the thermostat assembly further comprises a temperature switch inserted into the carrier structure.

59. The carrier apparatus according to claim 44, wherein the carrier structure comprises a base structure that comprises a bottom plate, an adjusting plate, and an adjusting assembly, and the bottom plate is connected to the adjusting plate through the adjusting assembly, and a position of the adjusting plate relative to the bottom plate is adjustable, the carrier structure being connected to the adjusting plate.

60. The carrier apparatus according to claim 59, wherein the adjusting assembly comprises adjusting members, positioning insertion members, and fixing members, and at least three adjusting members are provided; the positioning insertion members comprise a line positioning member, a plane positioning member, and a point positioning member; the three adjusting members are connected to the line positioning member, the plane positioning member, and the point positioning member, respectively, in one-to-one correspondence; the fixing members are connected to the adjusting plate and the bottom plate.

61. The carrier apparatus according to claim 60, wherein the fixing member comprises a fixing screw, a Belleville spring, and a fixing washer; the fixing screw penetrates into the adjusting plate and is connected to the bottom plate, the Belleville spring and the fixing washer both sleeve the fixing screw, and the Belleville spring is configured to press the adjusting plate tightly toward the bottom plate.

62. A biomolecule detection system, comprising:
the carrier apparatus according to claim 44, which is configured to carry the chip, the chip being provided with a biomolecule to be detected therein;
a liquid path apparatus, configured to provide a reaction liquid for the chip so as to cause the biomolecule to undergo a biochemical reaction with the reaction liquid; and
an imaging apparatus, configured to image the reacted biomolecule.

63. The biomolecule detection system according to claim 62, wherein the liquid path apparatus comprises manifold assemblies connected to the carrier structure, and the liquid path apparatus communicates with the chip through the manifold assemblies;
mounting holes are formed in the carrier structure; the manifold assembly comprises a manifold, a manifold seat, and floating springs; the manifold penetrates through the mounting hole, and the floating springs are connected to the manifold and the manifold seat and configured to drive the manifold to abut against the chip;
the manifold assembly further comprises flow channel guiding pins detachably connected to the manifold seat, and the manifold is in slidable fit with the flow channel guiding pins;
wherein the adsorption groove channel is arranged at least partially around the mounting holes;
mounting holes are formed in the carrier structure; the manifold assembly comprises a manifold, a manifold seat, and a fastener; the manifold penetrates through the mounting hole, and the fastener is connected to the manifold and the manifold seat and configured to drive the manifold to abut against the chip.
